(19) United States
(12) Patent Application Publication
(10) Pub. No.: US 2013/0110661 A1
(43) Pub. Date: May 2, 2013

(54) APPLICATION STORE DELIVERED PLATFORM COMPONENTS

(71) Applicants: Sam George, Kenmore, WA (US); Akhilesh Kaza, Sammamish, WA (US)

(72) Inventors: Sam George, Kenmore, WA (US); Akhilesh Kaza, Sammamish, WA (US)

(73) Assignee: MICROSOFT CORPORATION, Redmond, WA (US)

(21) Appl. No.: 13/284,720

(22) Filed: Oct. 28, 2011

(51) Int. Cl. G06Q 30/06

(52) U.S. Cl. 705/26.1

(57) ABSTRACT

The present invention extends to methods, systems, and computer program products for promoting the creation and use of application components in applications by distributing the application components in an application store. An application store hosts application components in conjunction with applications which use the application components. The application store tracks which components an application uses to distribute proceeds of the sale of an application among the owners of the application and application components used in the application. The application store may also store augmentations to a development platform to enable a development platform to be augmented between releases of the development platform.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Application stores are used to distribute applications (e.g. apps for smart phones) in a user friendly way. The application store provides a central location where application developers can sell their applications and users can locate these applications. When an application is sold, the application store owner distributes the proceeds to the sold application's owner and generally retains a portion of the proceeds as the cost of hosting the application in the application store.

This model provides various benefits that promote application development and distribution. Because application developers know they will have a highly visible location to sell their applications, application developers are encouraged to create applications. Additionally, because users know that the application store is likely to distribute an application that will match their needs, users are encouraged to visit the application store to locate applications.

### BRIEF SUMMARY

The present invention extends to methods, systems, and computer program products for delivering platform components from an application store.

In one embodiment, a submitted application package is received. The application package represents an application that is to be offered for sale at an application store and includes a plurality of components. It is detected that a first party owns at least one component from among the plurality of components. It is also detected that a second different party owns at least one other component from among the plurality of components. Component ownership data is stored along with the application package. The component ownership data indicates ownership of each of the plurality of components.

Purchasing information is received from another computer system. The purchasing information indicates that the application is to be purchased from the application store. The purchasing data also transfers funds for a corresponding specified purchase price of the application. In response to receiving the purchasing information, a determination is made regarding a first amount of the purchase price that is to be paid to the first party, and a second amount of the purchase price that is to be paid to the second party based on the component ownership data.

In another embodiment, a version of a development platform is released by a party. The version of the development platform is received at the application store. Then, an augmentation to the version of the development platform is received at the application store. The augmentation is released by another party, and augments the functionality of the development platform.

An application is received at the application store. The application is dependent on the development platform including the augmentation to the development platform.

A request to purchase the application from the application store is received from a requesting device. A determination is made that at least one of the development platform or the augmentation is not installed on the requesting device. In response to the determination, the requesting device is updated to include the at least one of the development platform or the augmentation.

This summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example computer architecture that facilitates allocating received funds used to purchase an application from the application store.

FIG. 2 illustrates an example computer architecture that facilitates third party augmentation of a development platform.

FIG. 3 illustrates a flow chart of an example method for allocating received funds used to purchase an application from the application store.

FIG. 4 illustrates a flow chart of an example method for third party augmentation of a development platform.

### DETAILED DESCRIPTION

The present invention extends to methods, systems, and computer program products for delivering platform components from an application store.

In one embodiment, a submitted application package is received. The application package represents an application that is to be offered for sale at an application store and includes a plurality of components. It is detected that a first party owns at least one component from among the plurality of components. It is also detected that a second different party owns at least one other component from among the plurality of components. Component ownership data is stored along with the application package. The component ownership data indicates ownership of each of the plurality of components.

Purchasing information is received from another computer system. The purchasing information indicates that the application is to be purchased from the application store. The purchasing data also transfers funds for a corresponding specified purchase price of the application. In response to receiving the purchasing information, a determination is made regarding a first amount of the purchase price that is to be paid to the first party, and a second amount of the purchase price that is to be paid to the second party based on the component ownership data.

In another embodiment, a version of a development platform is released by a party. The version of the development platform is received at the application store. Then, an augmentation to the version of the development platform is received at the application store. The augmentation is released by another party, and augments the functionality of the development platform.

An application is received at the application store. The application is dependent on the development platform including the augmentation to the development platform.

A request to purchase the application from the application store is received from a requesting device. A determination is made that at least one of the development platform or the augmentation is not installed on the requesting device. In response to the determination, the requesting device is updated to include the at least one of the development platform or the augmentation.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

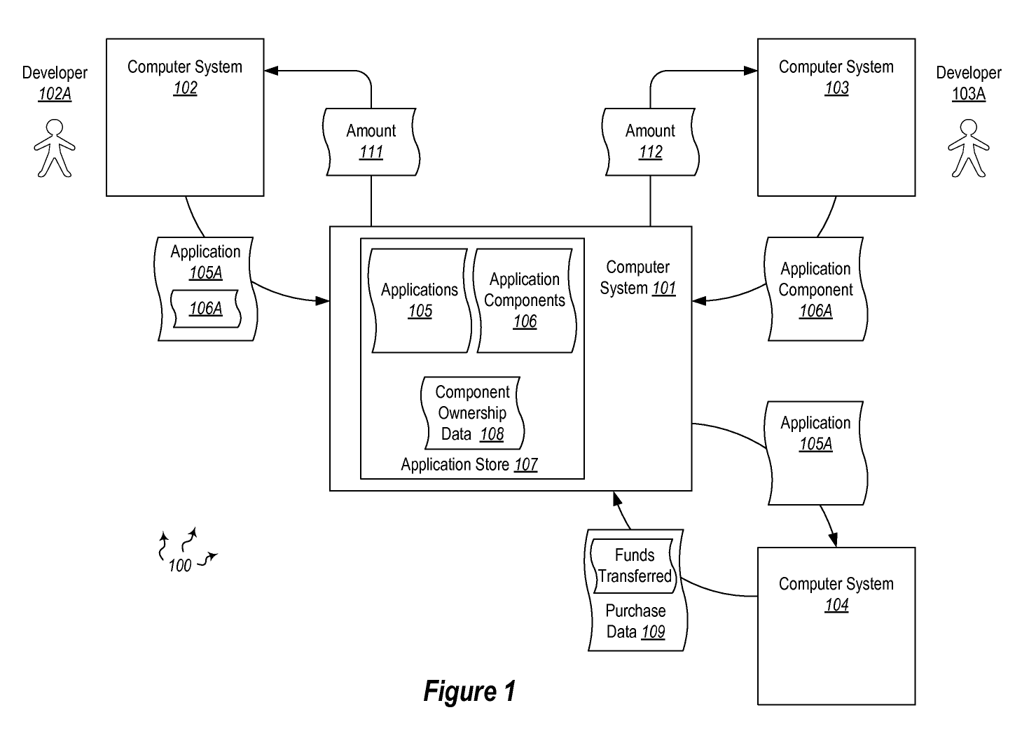

FIG. 1 illustrates an example computer architecture 100 that facilitates allocating received funds used to purchase an application from the application store. Referring to FIG. 1, computer architecture 100 includes computer system 101, 102, 103, and 104. Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system 101 hosts application store 107. Computer system 101 provides access to application store 107 to enable developers to submit applications 105 and application components 106 to the application store 107 and to enable users to locate and purchase applications 105. Computer systems 102 and 103 represent computer systems used by developers 102A and 103A respectively to submit applications or application components to the application store 107 hosted by computer system 101. Computer system 104 represents a user's computer system that is used to access the application store 107. In some embodiments, when a user purchases an application from the application store 107, the application is transferred from computer system 101 to computer system 104 where the application is installed.

Although computer system 101 is shown as a single computer system, the application store can be hosted on (or distributed among) a plurality of computer systems (e.g. servers). For example, computer system 101 can represent a cloud in the Internet. Accordingly, the architecture of FIG. 1 exemplifies a simplified environment in which the present invention can be implemented.

As depicted, application store 107 contains applications 105 and application components 106. Application components 106 are components that a development platform allows an application (e.g. in application 105) to use. For example, an application component can comprise primitive controls such as textboxes and buttons, complete controls such as panorama and pivot provided by Windows Phone, background services, and compute libraries such as physics libraries, etc.

Applications 105 and application components 106 are submitted to the application store by developers. Application developers can access application store 107 to obtain application components to use in an application. For example, FIG. 1 shows that developer 103A at computer system 103 submits application component 106A to application store 107. Subsequently, developer 102A at computer system 102 can access application component 106A in the application store 107 to incorporate application component 106A directly in application 105A or refer to application component 106A in application 105A as further described below. Developer 102A can then provide application 105A to application store 107 where it is hosted for distribution.

Application store 107 maintains component ownership data 108 regarding which application components are provided through the application store and a price for the use of each application component within an application. Accordingly, application store 107 provides a central location where an application developer can search for and obtain application components to use within an application the developer is developing.

An application developer can incorporate an application component in an application under development in at least two ways. For example, an application component can be directly included in an application package submitted to the application store. That is, the code that implements the application component can be obtained by the application developer and included directly with the code of the application.

Alternately, the application component can be referred to within the code of the application package. For example, an application package can indicate that it is dependent on an application component. In this alternate way, the code that implements the application component is not included in the application package submitted by the application developer to the application store. Instead, the application store can identify such dependencies and ensure that the application components are included with the application whenever the application is distributed. For example, the application store can install the application component prior to the application when the application is purchased.

An application component referenced within an application can also refer to other application components. In other words, there can be multiple levels of dependencies within an application package distributed by the application store. In some embodiments, an application can include some application components directly in the application package, and include references to other application components.

Whether an application component is directly included or the application component is referenced, the application store tracks which application components an application uses to determine how to distribute proceeds of the sale of the application. For example, if an application is submitted to the application store to be sold, application store 107 can detect that the application uses application component A and application component B. When the application is sold, application store 107 determines how much of the sale proceeds are to be distributed to the owner of the application, the owner of application component A, and the owner of application component B. Application store 107 can refer to component ownership data 108 to determine the price for each component's use within the application.

Accordingly, if an application sold for $1.00 and the price for components A and B were $0.05 and $0.10 respectively, $0.05 would be distributed to the owner of application component A, $0.10 would be distributed to the owner of application component B. The remainder (minus any amount that application store 107 retains as a fee) would be distributed to the application owner.

The application store can determine that an application uses an application component in various ways. For example, the application store can inspect an application package when it is submitted to the application store to determine which (if any) application components are included within (or referred to by) the code of the application package. Then, the application store can build a list of applications with the components that each uses and include the list in component ownership data 108. The inspection could also be performed when the application is purchased rather than when the application is submitted to the application store.

When an application is purchased, application store 107 ensures that any application components referred to by the application are installed with the application. For example, if an application refers to a platform component of a platform that the application depends on to execute, application store 107 can ensure that the platform component is transferred to the purchasing device in conjunction with the application.

In some embodiments, application store 107 can make all application components that do not perform protected access to resources of a computer system available to be included within an application package. On the other hand, application store 107 can make all application components that perform protected access to be referenced within the application package. For example, an application component that performs protected I/O operations may only be made available to developers through reference.

In this way, access to the code that performs protected access is restricted. This restriction helps maintain the integrity of such application components. When a purchased application includes a reference to a protected access application component, application store 107 can detect the reference and ensure that the referenced application component is included with the application when sent to a purchasing device.

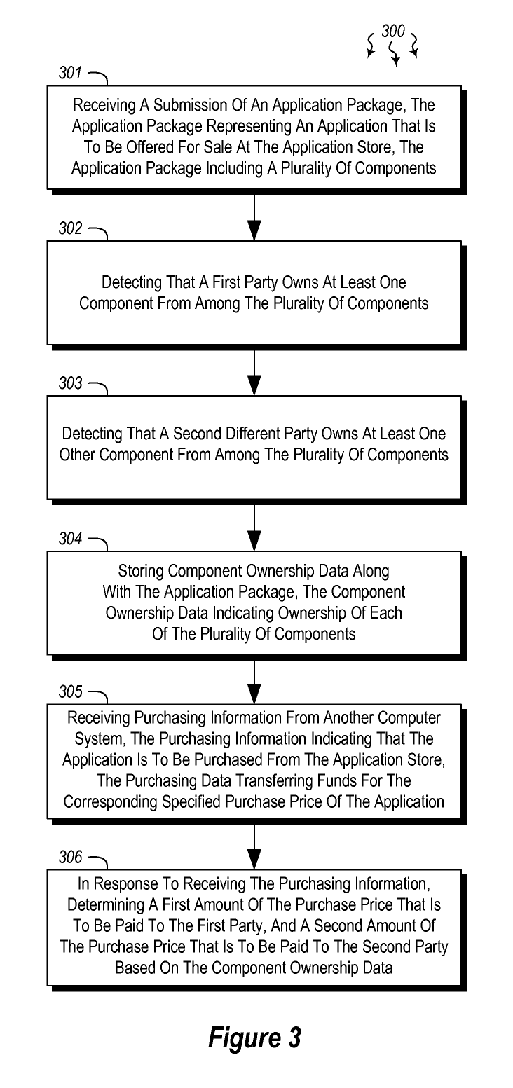

FIG. 3 illustrates a flow chart of an example method 300 for allocating received funds used to purchase an application from an application store among a plurality of parties. Method 300 will be described with respect to the components and data of computer architecture 100.

Method 300 includes an act of receiving a submission of an application package, the application package representing an application that is to be offered for sale at the application store, and including a plurality of components (act 301). For example, computer system 101 can receive application package 105A from computer system 102 to be offered for sale at application store 107. The plurality of application components in application package 105A can include application component 106A.

Method 300 includes an act of detecting that a first party owns at least one component from among the plurality of components (act 302). For example, application store 107 can detect that application 105A includes at least one component owned by developer 102A. The first party that owns the at least one component may be the same party that owns the application, or may be a separate party.

Method 300 includes an act of detecting that a second different party owns at least one other component from among the plurality of components (act 303). For example, the application store 107 can detect that application 105A includes application component 106A that is owned by developer 103A.

Method 300 includes an act of storing component ownership data along with the application package, the component ownership data indicating ownership of each of the plurality of components (act 304). For example, the application store 107 can store component ownership data 108 indicating that application 105A includes application component 106A.

Component ownership data 108 can also indicate an amount of a sales price for application 105A. A portion of the sales price can be distributed to the second different party when the application 105A is purchased. For example, component ownership data 108 can indicate that a fixed amount or a percentage of a sales price is to be distributed to developer 103A when an application, such as application 105A incorporating application component 106A, is sold.

Method 300 includes an act of receiving purchasing information from another computer system, the purchasing information indicating that the application is to be purchased from the application store, the purchasing data transferring funds for the corresponding specified purchase price of the application (act 305). For example, application store 107 can receive purchasing information 109 from computer system 104.

Method 300 includes an act of, in response to receiving the purchasing information, determining a first amount of the purchase price that is to be paid to the first party, and a second amount of the purchase price that is to be paid to the second party based on the component ownership data (act 306). For example, application store 107 can determine, based on component ownership data 108, that an amount 111 is to be paid to developer 102A and an amount 112 is to be paid to developer 103A. Application store 107 may then transfer amount 111 to developer 102A and amount 112 to developer 103A.

Other embodiments of the present invention also provide the ability for one party to augment a development platform released by another party. For example, many first party software companies provide development platforms (or SDKs) that third party developers can use to develop applications. Examples of development platforms include Microsoft's Windows Phone, Apple's iOS, and Google's Android. A development platform can also be construed to include any application frameworks supported by a development environment such as Silverlight and XNA for Windows Phone.

From time to time, a first party software company can release a version of a development platform that lacks at least some desired functionality. This may be due, for example, to the company not having sufficient time prior to a planned release date to implement all the desired functionality for a particular version.

Additionally, after release of a development platform version, a company may receive third party developer or user feedback providing suggestions for additional functionality that can be added to the development platform. The company can take these suggestions and incorporate the additional functionality in a subsequent version of the development platform. However, it may be undesirable to wait until the subsequent version of the development platform to have access to the added functionality.

Accordingly, the present invention provides a way for third parties to augment a released version of a development platform using an application store. In this way, functionality can be added to a development platform between releases of the development platform rather than having to wait until the next release of the development platform to use the added functionality.

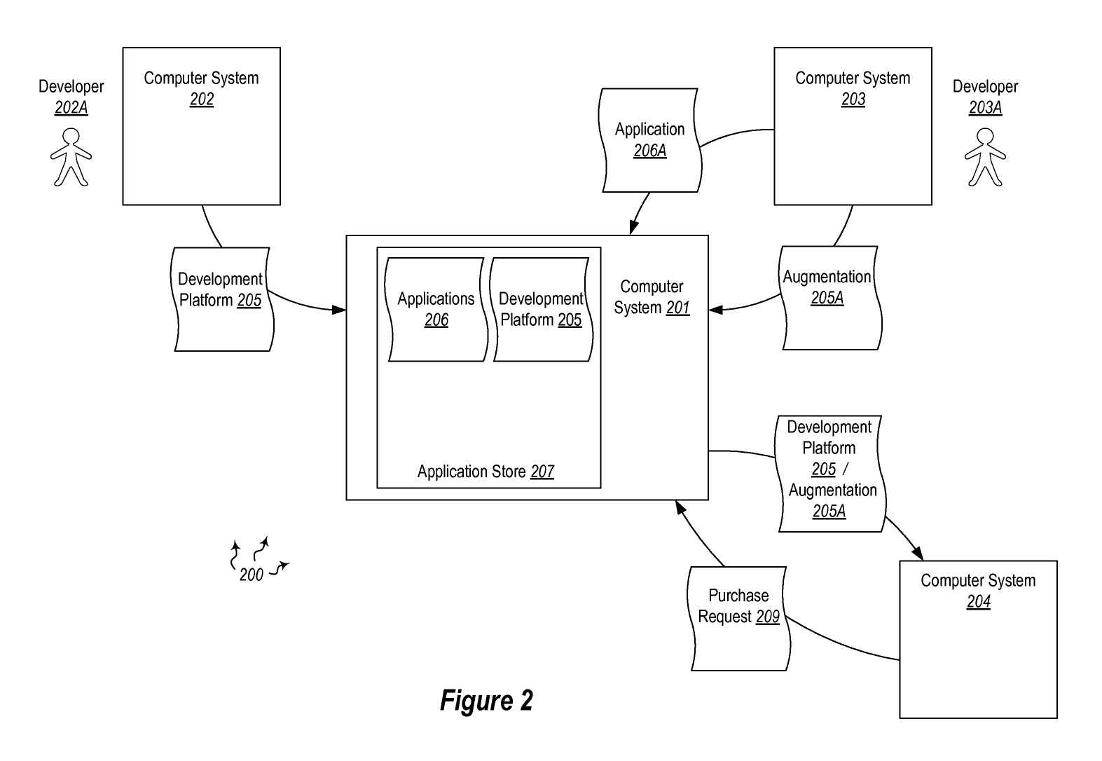

FIG. 2 illustrates an example computer architecture 200 that facilitates third party augmentation of a development platform. As depicted in FIG. 2, when development platform 205 is released by party 202A, development platform 205 can be made available to developers so that developers can develop applications that execute on development platform 205. Development platform 205 can be made available in application store 207 or through other means (e.g. party 202A′s website). Once development platform 205 is available, third party developers can develop augmentations to development platform 205. With these augmentations, development platform 205 provides additional functionality that can be leveraged by application developers to create applications for execution on development platform 205.

For example, party 203A can develop augmentation 205A to augment the functionality provided by development platform 205. Augmentation 205A can provide functionality that is not otherwise provided by development platform 205, but can be used (e.g. by application developers) as if the augmentations were part of development platform 205A.

Augmentation 205A can be stored in the application store 207. Thus, a first party's development platform can be augmented with additional functionality even between releases of the development platform. Accordingly, applications developed to run on the development platform can also rely on augmentations to the development platform that are distributed via the application store.

When an application is purchased, the application store can determine whether any augmentations to the development platform are to be transferred to ensure that appropriate platform functionality is installed on the purchasing device in conjunction with the application. Additionally, if the development platform is not available on the purchasing device, it can also be installed on the purchasing device prior to the augmentation so that the application has access to appropriate platform functionality.

The application store can also make the development platform and its augmentations independently available for distribution. That is, a development platform can be treated in a similar manner as any other application made available in the application store as described above with respect to FIG. 1.

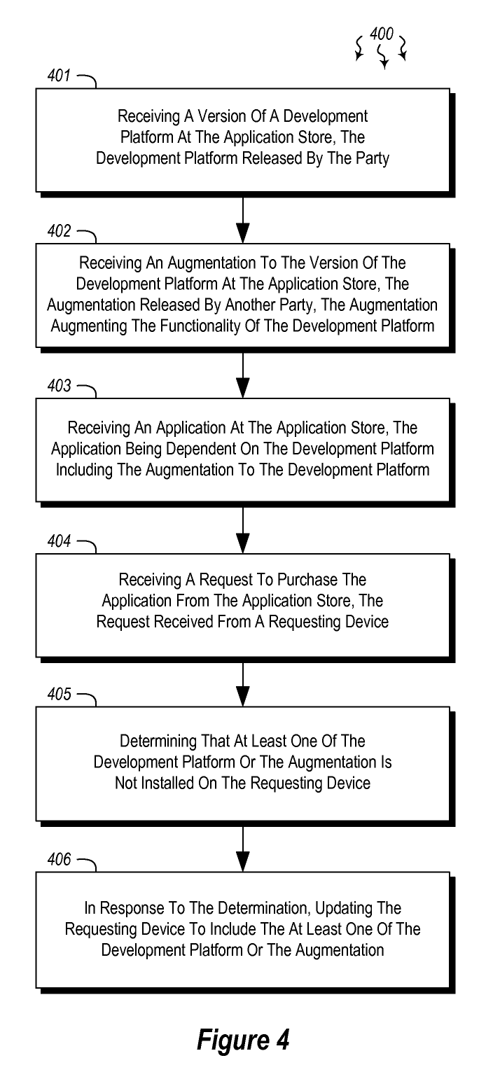

FIG. 4 illustrates a flow chart of an example method 400 for third party augmentation of a development platform. Method 400 will be described with respect to the components and data of computer architecture 200.

Method 400 includes an act of receiving a version of a development platform at the application store, the development platform released by the party (act 401). For example, application store 207 can receive development platform 205 released by party 202A from computer system 202.

Method 400 includes an act of receiving an augmentation to the version of the development platform at the application store, the augmentation released by another party, the augmentation augmenting the functionality of the development platform (act 402). For example, application store 207 can receive augmentation 205A developed by party 203A from computer system 203. Augmentation 205A can augment the functionality provided by development platform 205.

Method 400 includes an act of receiving an application at the application store, the application being dependent on the development platform including the augmentation to the development platform (act 403). For example, application store 207 can receive application 206A developed by party 203A from computer system 203. Application 206A can require development platform 205 and augmentation 205A to be installed on a device in order to execute properly on the device.

Although FIG. 2 shows application 206B being received from the same party that developed augmentation 205A, application 206A could be received by any party including party 202A or another separate party not depicted in FIG. 2. Further, application 206A can be dependent on other augmentations to the development platform 205 developed by party 203A or any other party.

Method 400 includes an act of receiving a request to purchase the application from the application store, the request received from a requesting device (act 404). For example, application store 207 can receive a purchase request 209 from computer system 204 requesting to purchase application 206A.

Method 400 includes an act of determining that at least one of the development platform or the augmentation is not installed on the requesting device (act 405). For example, application store 207 can determine that development platform 205 and/or augmentation 205A are not installed on computer system 204.

Method 400 includes an act of in response to the determination, updating the requesting device to include the at least one of the development platform or the augmentation (act 406). For example, application store 207 can transmit the development platform 205 and/or the augmentation 205A to computer system 204 to enable application 206A to execute properly once installed on computer system 204.

In some embodiments, application 206A can include application components similar to application component 106A described above with respect to FIG. 1. Additionally, in some embodiments, the application store 207 can determine an amount of the purchase price paid for the application 206A that is to be distributed to an owner of the augmentation 205A.

In other embodiments, computer system 204 requests development platform 205 and augmentation 205A from application store 207 to enable a developer on computer system 204 to develop an application. For example, a developer can desire to create an application that relies on the development platform as well as the added functionality provided by augmentation 205A.

In a specific example, a second party hardware provider (e.g. a mobile phone manufacturer such as Samsung or Nokia) can create augmentations to a development platform (e.g. Windows Phone) that are specific to a particular mobile phone's hardware. For example, Samsung can desire to modify or augment the development platform to provide functionality that application developers can use to develop applications that are specific to Samsung phones that run the development platform. Such augmentations could be made available in the application store 207 to facilitate the development of such applications.

In some cases, these augmentations could perform protected access to the hardware of the phone and therefore could be made available to developers only through reference (as opposed to allowing the augmentation to be directly included in the application package) as described above with respect to FIG. 1. In this manner, features can be added to a development platform by second (e.g. hardware providers) or third party providers even between releases of the development platform.

Accordingly, embodiments of the present invention provide a centralized location for the distribution of application components and for the augmentation of development platforms in a manner that enables the distribution of proceeds from the sale of such components and/or augmentations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system including an application store offering a plurality of applications for sale, each of the plurality of offered applications having a corresponding specified purchase price, a method of allocating received funds used to purchase an application from the application store, the method comprising:
receiving a submission of an application package, the application package representing an application that is to be offered for sale at the application store, the application package including a plurality of components;
detecting that a first party owns at least one component from among the plurality of components;
detecting that a second different party owns at least one other component from among the plurality of components;
storing component ownership data along with the application package, the component ownership data indicating ownership of each of the plurality of components;
receiving purchasing information from another computer system, the purchasing information indicating that the application is to be purchased from the application store, the purchasing data transferring funds for a corresponding specified purchase price of the application; and
in response to receiving the purchasing information, determining a first amount of the purchase price that is to be paid to the first party, and a second amount of the purchase price that is to be paid to the second party based on the component ownership data.

2. The method of claim 1, wherein detecting that a second different party owns at least one other component from among the plurality of components comprises detecting that the application package includes a reference to the at least one other component owned by the second different party.

4. The method of claim 2 wherein upon the application package being purchased, the at least one other component owned by the second different party is retrieved and distributed with the application package.

5. The method of claim 2, wherein the at least one other component owned by the second different party has restricted access to resources of a computer system on which the at least one other component is installed.

6. The method of claim 2, wherein the at least one other component owned by the second different party includes one or more references to additional components.

7. The method of claim 1, wherein the at least one other component owned by the second different party is directly included within the application package.

8. The method of claim 7, further comprising:
distributing the application package to the other computer system to be installed on the other computer system.

9. The method of claim 1, wherein the application is designed to execute on a development environment, the method further comprising:
receiving a submission of an augmentation to the development environment;
determining that the application relies on the augmentation to the development environment; and
transmitting the augmentation to the development environment to the other computer system so that the augmentation is installed on the other computer system prior to the application being installed on the other computer system.

10. The method of claim 1, wherein the other computer system is a mobile device.

11. The method of claim 1, wherein the application component comprises one of a primitive control, a complete control, a background service, or a compute library.

12. One or more computer storage devices storing computer executable instructions which when executed by one or more processors perform the method of claim 1.

13. At a computer system, the computer system including an application store offering software component for sale, a method of enabling a development platform released by one party to be augmented by other parties, the method comprising:
receiving a version of a development platform at the application store, the development platform released by the party;
receiving an augmentation to the version of the development platform at the application store, the augmentation released by another party, the augmentation augmenting the functionality of the development platform;
receiving an application at the application store, the application being dependent on the development platform including the augmentation to the development platform;
receiving a request to purchase the application from the application store, the request received from a requesting device;
determining that at least one of the development platform or the augmentation is not installed on the requesting device; and
in response to the determination, updating the requesting device to include the at least one of the development platform or the augmentation.

14. The method of claim 13, wherein the party and the other party are the same party.

15. The method of claim 14, further comprising:
determining that the application is dependent on one or more application components stored in the application store; and
updating the requesting device with the one or more application components.

16. The method of claim 15, wherein the one or more application components perform protected access to resources of the requesting device.

17. The method of claim 13, wherein the requesting device is a mobile device.

18. One or more computer storage devices storing computer executable instructions which when executed by one or more processors perform the method of claim 13.

19. At a computer system, the computer system including an application store offering a plurality of applications for sale, each of the plurality of offered applications having a corresponding specified purchase price, a method of allocating received funds used to purchase an application from the application store, the method comprising:
receiving a submission of an application package, the application package representing an application that is to be offered for sale at the application store, the application package including a plurality of components, the application designed to execute on a version of a development platform that has been augmented by an augmentation;
detecting that a first party owns at least one component from among the plurality of components;
detecting that a second different party owns at least one other component from among the plurality of components;
storing component ownership data along with the application package, the component ownership data indicating ownership of each of the plurality of components;
receiving purchasing information from another computer system, the purchasing information indicating that the application is to be purchased from the application store, the purchasing data transferring funds for the corresponding specified purchase price of the application;
in response to receiving the purchasing information, determining a first amount of the purchase price that is to be paid to the first party, and a second amount of the purchase price that is to be paid to the second party based on the component ownership data;
determining that a version of the development platform without the augmentation is installed on the other computer system; and
updating the other computer system with the augmentation prior to updating the other computer system with the application.

20. The method of claim 19, wherein the other computer system is a mobile device.
